(19) United States
(12) Patent Application Publication
(10) Pub. No.: US 2023/0089911 A1
(43) Pub. Date: Mar. 23, 2023

(54) ADJUSTABLE FOILS

(71) Applicant: SIRONA DESIGN LIMITED, Solihull West Midlands (GB)

(72) Inventor: ALEXANDER CHARLES BERRY, London (GB)

(21) Appl. No.: 17/800,795

(22) PCT Filed: Feb. 19, 2021
(86) PCT No.: PCT/GB2021/050414

§ 371 Date: Aug. 18, 2022

(30) Foreign Application Priority Data
Feb. 21, 2020 (GB) 2002453.5

(51) Int. Cl. B64C 3/48; B63H 9/061; B64C 3/14; B64C 3/56

(52) U.S. Cl. CPC B64C 3/48; B63H 9/061; B64C 3/14; B64C 3/56; B64C 2003/445

(57) ABSTRACT

An adjustable foil having a suction surface and a pressure surface. The foil comprises an adjustable internal frame comprising a base, a plurality of articulately connected sections forming the suction surface of the foil, arranged consecutively from the leading edge of the foil to the trailing edge of the foil, and a plurality of frame struts, each articulately connected to the base and to a section of the plurality of sections. The foil is movable from a collapsed configuration to an expanded configuration by rotating the frame struts with respect to the base.

### FIELD OF THE INVENTION

The present invention concerns adjustable foils, such as aerofoils, hydrofoils and the like. More particularly, but not exclusively, the invention concerns adjustable foils with adjustable internal frames.

### BACKGROUND OF THE INVENTION

Foils are objects with a shape that means that when they are positioned appropriately in a moving fluid, a lift is generated on the foil, i.e. a force perpendicular to the fluid flow. Where the fluid is air, the foil is called an aerofoil, and where the fluid is water, the foil is called a hydrofoil. Examples of foils are aircraft wings, ship hydrofoils, car spoilers and the like.

A cross-section of a foil is shown in FIG. 1. The foil 100 has a suction surface 101 (also known as the upper surface) and a pressure surface 102 (also known as the lower surface). Both run from a leading edge 103 to a trailing edge 104. Due to the shape of the foil 100, the distance from the leading edge 103 to the trailing edge 104 is greater for the suction surface 101 than the pressure surface 102, leading to a comparatively lower pressure from the surrounding fluid on the suction surface 101 than on the pressure surface 102. This pressure difference generates (or at least contributes to) a lift force on the foil.

Adjustable wings are known. For example, GB 797376 A1 (ML Aviation Co Ltd) published 2 July 1958 discloses an inflatable wing that is collapsible horizontally, to allow the overall width of an aircraft to be reduced.

US 2013/200208 A1 (Raytheon Company) published 8 Aug. 2013 discloses an aircraft wing with foldable ribs, allowing the length of the wings (in the direction of aircraft travel) to be changed, allowing the wing to have a stowed condition and a deployed condition.

US 2010/116937 A1 (Raytheon Company) published 13 May 2010 discloses a wing for an unmanned aerial vehicle (UAV), which includes a box that can be expanded from a collapsed condition to increase the thickness of the wing.

However, it would be advantageous to have a foil that could be adjusted to change the fluid dynamic properties of the foil, and not merely so it can be collapsed when not needed.

The present invention seeks to solve and/or mitigate some or all of the above-mentioned problem. Additionally and/or alternatively, the present invention seeks to provided improved adjustable foil.

### SUMMARY OF THE INVENTION

In accordance with a first aspect of the invention, there is provided an adjustable foil having a suction surface and a pressure surface, each of the suction surface and the pressure surface extending from a leading edge of the foil to a trailing edge of the foil, wherein the foil comprises an adjustable internal frame comprising:
a base;
a plurality of articulately connected sections forming the suction surface of the foil, wherein the plurality of sections are arranged consecutively from the leading edge of the foil to the trailing edge of the foil; and
a plurality of frame struts, wherein each frame strut is articulately connected to the base, and articulately connected to a section of the plurality of sections;
wherein the foil is movable from a collapsed configuration to an expanded configuration by rotating the frame struts with respect to the base.

By having the suction surface provided by articulately connected sections, the shape of the suction surface can be adjusted by moving the sections with respect to each other. The frame struts being articulately connected to the sections and to the base allow the sections to be moved, while constraining their possible positions. In particular, the frame struts can be rotated with respect to the base so as to bring the sections closer to, or further away from, the base. When the sections are moved closest to the base, the foil is in the collapsed configuration, while when the sections are furthest away from the base, the foil is in the expanded configuration. The foil can also be in configurations between those two extremes.

Preferably, the internal frame further comprises one or more adjusting struts, each adjusting strut articulately connected to a frame strut at a point between the base and the section to which the frame strut is articulately connected. The adjusting struts can then be used to move the frame struts, to change the configuration of the foil. Advantageously, each adjusting strut is articulately connected to a rail slidably mounted to the base, and the foil is movable from the collapsed configuration to the expanded configuration by moving the rail with respect to the base, to rotate the frame struts with respect to the base. Thus, the configuration of the foil can be changed simply by sliding the rail with respect to the base. The adjustable foil may further comprise a drive motor to move the rail with respect to the base. Alternatively, the adjustable foil may further comprise a hydraulic mechanism to move the rail with respect to the base, or any other suitable mechanism.

Alternatively, the length of each adjusting strut can be increased or decreased, and wherein the foil is movable from the collapsed configuration to the expanded configuration by moving the rail with respect to the base, to rotate the frame struts with respect to the base. In this case, each adjusting strut may be articulately connected to the base. The adjustable foil may further comprise a drive motor, hydraulic mechanism or any other suitable mechanism to increase or decrease the length of each adjusting strut.

Preferably, each section of the plurality of sections is the same or a smaller length than the sections further from the leading edge of the foil. (In this case, there may be an initial section of a longer length, which is not one of the plurality of sections.)

Advantageously, the plurality of sections comprises a first set of sections of a first length and a second set of sections of a second length, wherein the second set of sections is further from the leading edge of the foil than the first set of sections, and wherein the second length is double the first length. There may be five sections in the first set of sections, and four sections in the second set of sections. Advantageously, the plurality of sections further comprises a third set of sections of a third length, wherein the third set of sections is further from the leading edge of the foil than the second set of sections, and wherein the third length is double the second length. There may be two sections in the third set of sections. The plurality of sections may comprise a leading section closer to the leading edge of the foil than the first set of sections. The plurality of sections may comprise a trailing section further from the leading edge of the foil than the second and third sets of sections. Alternatively and/or additionally, there may be a fourth set of sections comprising two sections, and there may be fifth set of sections comprising one section.

It will be appreciated that various other arrangements of sections could be provided in accordance with other embodiments of the invention.

The base of the internal frame may form the pressure surface of the foil. The base may include a shaped framework or the like, to give the pressure surface of the foil an appropriate shape. Such a framework or the like may be of a fixed shape, or may for example be an adjustable frame similar to that providing the shape of the suction surface.

Preferably, the adjustable foil further comprises an outer skin over the internal frame.

The foil may be an aerofoil. The aerofoil may be for an aircraft, such as an airplane or helicopter. The foil may be a wing. The foil may be part of a wing, fin, tailfin or the like. The foil may be a winglet. The foil may be a sail. The sail may be for a ship, boat, windsurfing board or the like. The foil may be a spoiler. The spoiler may be for a car or the like.

The foil may be a hydrofoil. The hydrofoil may be for a ship, boat or the like.

In accordance with a second aspect of the invention, there is provided a combination adjustable foil comprising:
a first adjustable foil as described above, and
a second adjustable foil as described above, mounted on the first adjustable foil,
wherein the second adjustable foil is positioned and oriented with respect to the first adjustable foil so that the leading edge of the first adjustable foil and the leading edge of the first adjustable foil form the leading edge of the combination adjustable foil, the trailing edge of the first adjustable foil and the trailing edge of the first adjustable foil form the trailing edge of the combination adjustable foil, and the pressure surface of the first adjustable foil expands in the opposite direction to the second adjustable foil.

In this way, the second adjustable foil can form the pressure surface of the first adjustable foil when the first adjustable foil is in the expanded configuration, and the first adjustable foil can form the pressure surface of the second adjustable foil when the second adjustable foil is in the expanded configuration.

The base of the internal frame of the first adjustable foil may be mounted the base of the internal frame of the second adjustable foil. Alternatively, the base of the internal frame of the first adjustable foil may be the base of the internal frame of the second adjustable foil, i.e. they may share a base. It will be appreciated that the first adjustable foil and second adjustable foil could be mounted together in various other ways in accordance with other embodiments of the invention.

Preferably, the combination adjustable foil further comprises an outer skin over the internal frame.

The combination adjustable foil may be an aerofoil. The aerofoil may be for an aircraft, such as an airplane or helicopter. The foil may be a wing. The combination adjustable foil may be part of a wing, fin, tailfin or the like. The combination adjustable foil may be a winglet. The combination adjustable foil may be a sail. The combination adjustable foil may be for a ship, boat, windsurfing board or the like. The combination adjustable foil may be a spoiler. The spoiler may be for a car or the like.

The combination adjustable foil may be a hydrofoil. The hydrofoil may be for a ship, boat or the like.

It will of course be appreciated that features described in relation to one aspect of the present invention may be incorporated into other aspects of the present invention.

### DESCRIPTION OF THE DRAWINGS

Embodiments of the present invention will now be described by way of example only with reference to the accompanying schematic drawings of which:

FIG. 1 is a cross-sectional view of a foil;

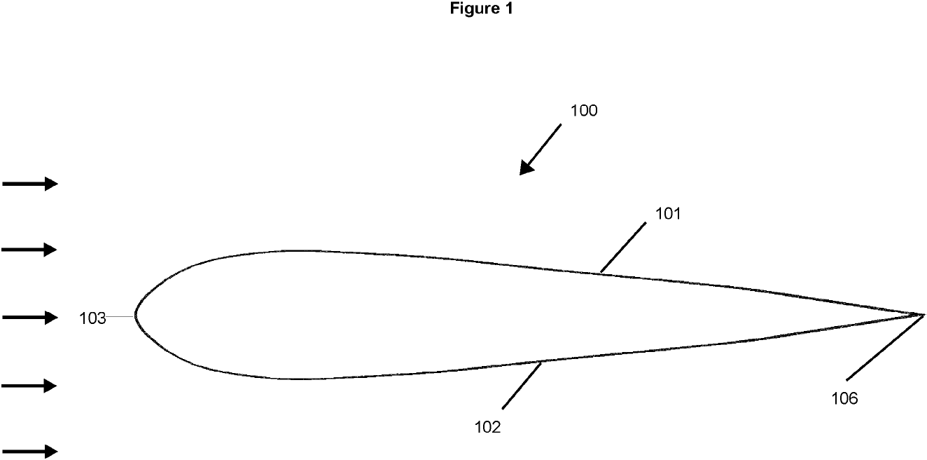

FIG. 2 is a perspective view of an adjustable foil in accordance with a first embodiment of the present invention;

FIG. 3a is a perspective view of a part of an adjustable internal frame of the adjustable foil of the first embodiment, in an expanded configuration;

FIG. 3b is a perspective view of the adjustable internal frame of the adjustable foil of the first embodiment, in a collapsed configuration;

FIG. 4a is a cross-sectional view of the adjustable internal frame of the adjustable foil of the first embodiment, in the expanded configuration;

FIG. 4b is a cross-sectional view of the adjustable internal frame of the adjustable foil of the first embodiment, in the collapsed configuration;

FIG. 5a is a further cross-sectional view of the adjustable internal frame of the adjustable foil of the first embodiment, in the expanded configuration;

FIG. 5b is a further cross-sectional view of the adjustable internal frame of the adjustable foil of the first embodiment, in a configuration between the expanded and collapsed configurations;

FIG. 5c is a further cross-sectional view of the adjustable internal frame of the adjustable foil of the first embodiment, in the collapsed configuration;

FIG. 6a is a cross-sectional view of a combined adjustable foil in accordance with a second embodiment of the invention, with its first adjustable foil in the expanded configuration and its second adjustable foil in the collapsed configuration;

FIG. 6b is a cross-sectional view of the combined adjustable foil of the second embodiment, with its first adjustable foil in the collapsed configuration and its second adjustable foil in the collapsed configuration;

FIG. 6c is a cross-sectional view of the combined adjustable foil of the second embodiment, with its first adjustable foil in the collapsed configuration and its second adjustable foil in the expanded configuration;

FIG. 7a is a side view of the combined adjustable foil of the second embodiment, with its first adjustable foil in the expanded configuration and its second adjustable foil in the collapsed configuration;

FIG. 7b is a perspective view of the combined adjustable foil of the second embodiment, with its first adjustable foil in the expanded configuration and its second adjustable foil in the collapsed configuration;

FIG. 7c is a perspective view of the combined adjustable foil of the second embodiment, with its first adjustable foil in the expanded configuration and its second adjustable foil in the collapsed configuration;

FIG. 7d is a perspective view of the combined adjustable foil of the second embodiment, with its first adjustable foil in the expanded configuration and its second adjustable foil in the collapsed configuration;

FIG. 7e is a perspective view of the combined adjustable foil of the second embodiment, with its first adjustable foil in the collapsed configuration and its second adjustable foil in the collapsed configuration; and

FIG. 7f is a perspective view of the combined adjustable foil of the second embodiment, with its first adjustable foil in the collapsed configuration and its second adjustable foil in the expanded configuration.

### DETAILED DESCRIPTION

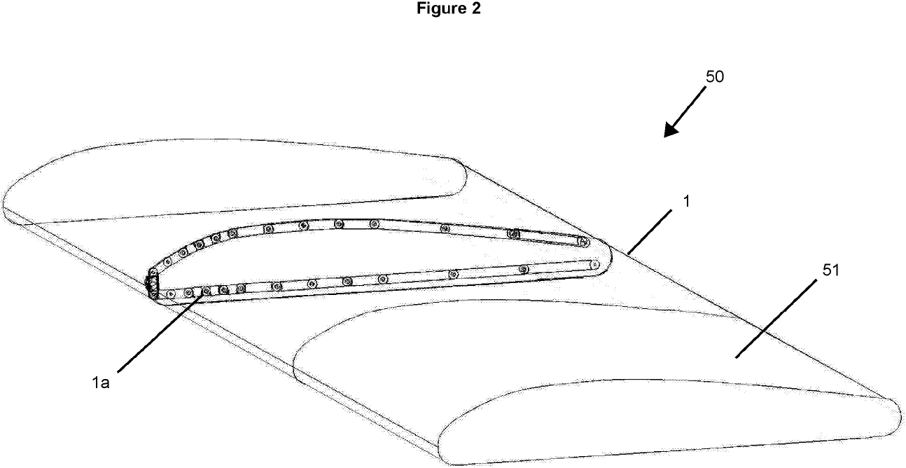

An adjustable foil in accordance with an embodiment of the invention is now described, with reference to FIGS. 2 to 5c. As shown in FIG. 2, the adjustable foil 50 comprises an outer skin, which covers an adjustable internal frame 1, as described in detail below. It will be appreciated that in embodiments of the invention the adjustable foil 50 may comprise multiple adjustable internal frames 1 spaced out within the interior of the adjustable foil 50. Mounted underneath the adjustable internal frame 1 is a shaped portion 1a, which is a frame of a fixed configuration and provides the shape of the pressure surface of the adjustable foil 50.

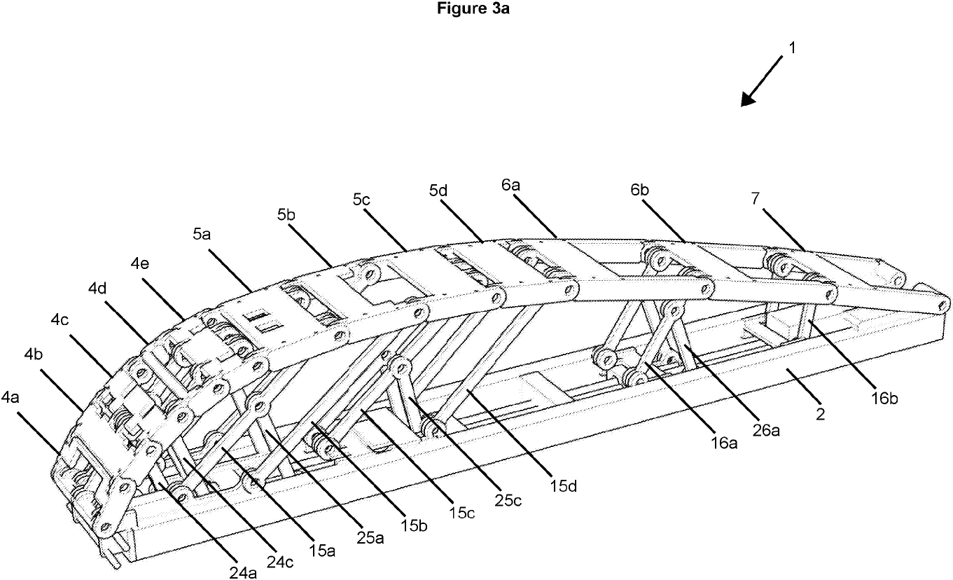

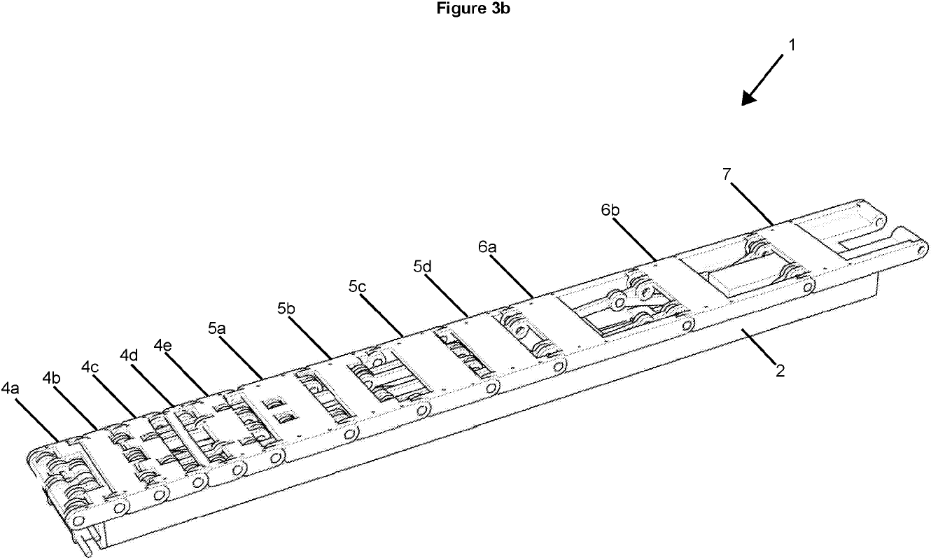

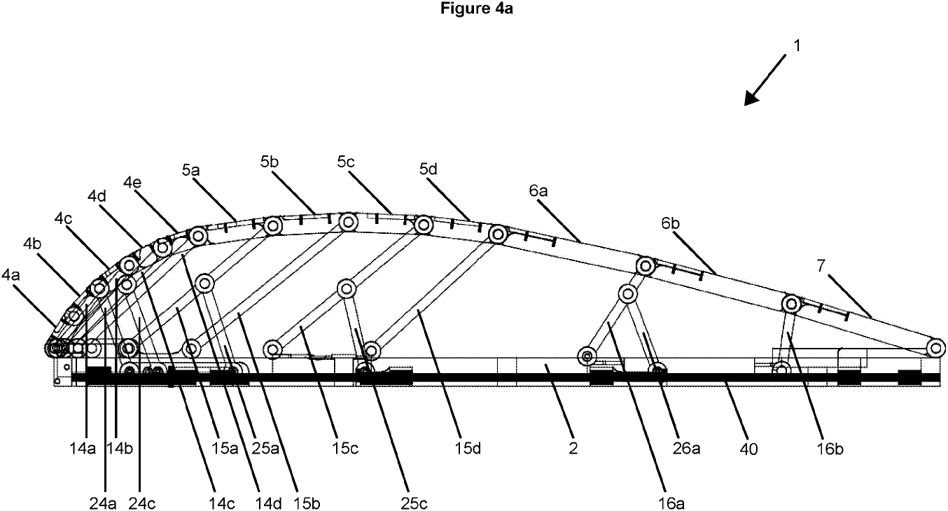

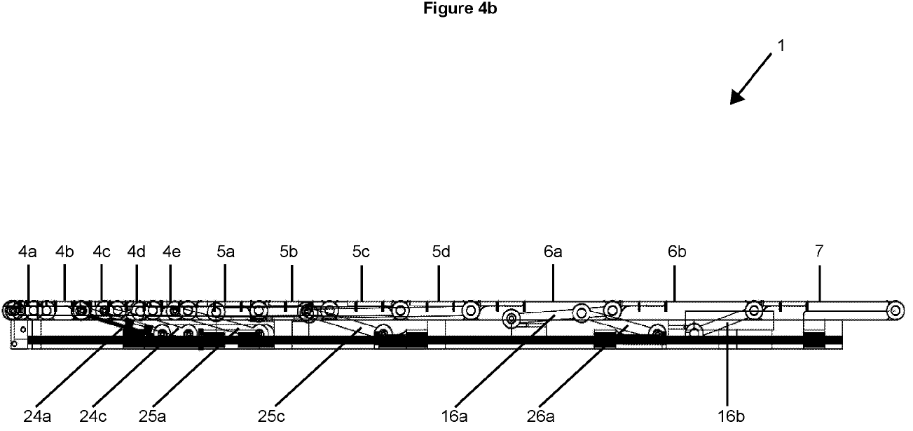

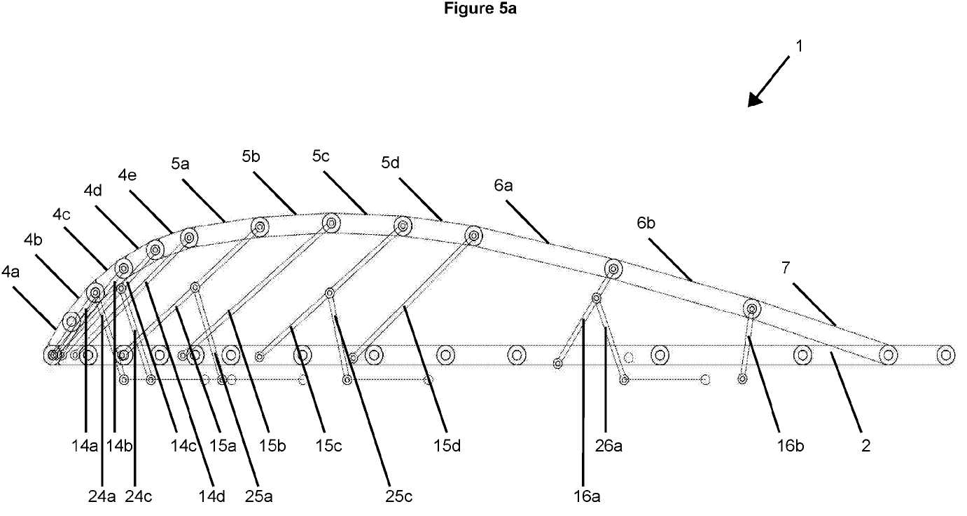

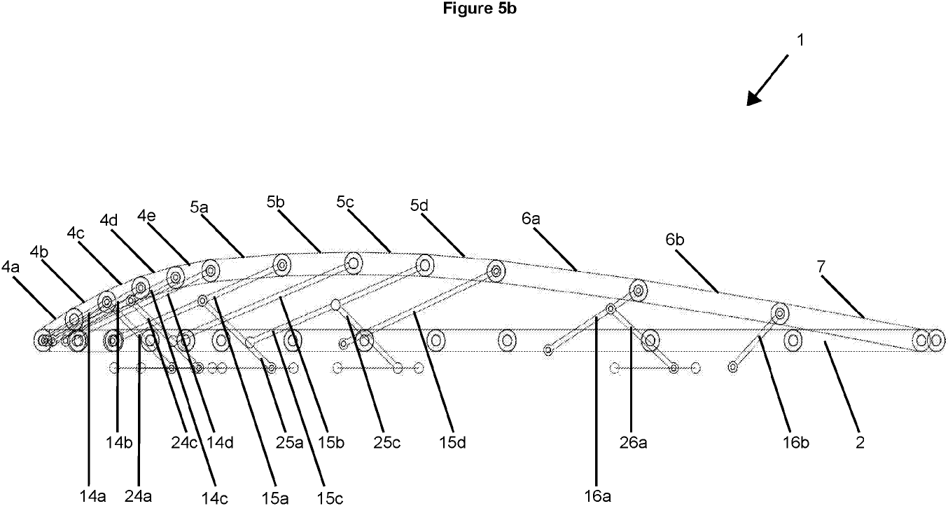

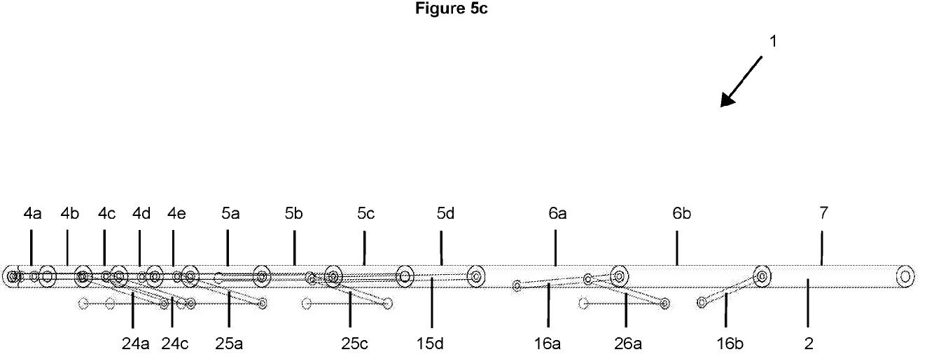

FIG. 3a is a perspective view of a part of the adjustable internal frame 1, in the expanded configuration. Cross-sectional views of the adjustable internal frame 1 in the expanded configuration are shown in FIGS. 4a and 5a. FIGS. 3b, 4b and 5c show the adjustable internal frame 1 in the collapsed configuration, while FIG. 5b shows the adjustable internal frame 1 in a configuration between the expanded and collapsed configurations.

The adjustable internal frame 1 comprises a base 2, which comprises a slidable rail 40, as described in more detail later below. The adjustable internal frame 1 further comprises a set of sections 4 to 7, which form the suction surface of the adjustable foil 50 (underneath the skin 51). It will be appreciated that in embodiments of the invention, the sections may extend across the width of the adjustable foil 50, and sections may be shared by more than one adjustable internal frame 1 where the adjustable foil 50 comprises a plurality.

The set of sections comprises a first set of four sections 4a to 4e. A first end of a first section 4a of the first set of sections 4 is articulately connected to an end of the base 2, to form the leading edge of the foil. The other end of the first section 4a is articulately connected to a first end of a second section 4b of the first set of sections 4. As can be seen from the Figures, the other sections 4b to 4e of the first set are then articulately connected together, to form a consecutive set of articulately connected sections. Each of the sections 4a to 4e of the first set is identical in length, i.e. in distance between articulately connected ends.

The end of the last section 4e not connected to the preceding section 4d is articulately connected to a first end of a first section 5a of a second set of four sections 5a to 5d. Similarly to the first set of sections 4a to 4e, as can be seen from the Figures the other sections 5b to 5d of the second set are then articulately connected together, to form a further consecutive set of articulately connected sections. Similarly again, each of the sections 5a to 5d of the second set is identical in length. However, the length of the sections 5a to 5d of the second set is twice the length of the sections 4a to 4e of the first set.

The end of the last section 5d not connected to the preceding section 5c is articulately connected to a first end of a first section 6a of a third set of two (rather than four) sections 6a and 6b. The second section 6b is then articulately connected to the other end of the first section 6a. Both of the sections 6a and 6b of the third set are identical in length, being twice the length of the sections 5a to 5d of the second set.

The other end of the section 6b is then articulately connected to a first end of a trailing section 7. The trailing section 7 is of similar, but not identical, length as the sections 6a and 6b of the third set. The other end of the trailing section 7 is slidably connected to the base 2, allowing it to move backward and forward with respect to the base 2, in the region of the end of the base 2 opposite to the end to which the leading section is connected.

The adjustable internal frame 1 further comprises pairs of frame struts 14a to 16b, which connect the sections 4b to 6b to the base 2. One end of each of the frame struts 14a to 16b is articulately connected at an appropriate position to the base 2. The other end of each of the frame struts 14a to 16b is then articulately connected to the sections 4b to 6b, in particular at the points at which each section is articulately connected to the next section further from the leading edge.

Thus, the frame strut 14a is articulately connected to the sections 4b and 4c, at the articulate connection by which the sections 4b and 4c are joined. Similarly, the frame strut 14b is articulately connected to the sections 4c and 4d, at their articulate connection. Continuing along the consecutive sections, the frame struts 14c; 14d; 15a; 15b; 15c; 15d; 16a; 16b are articulately connected to the articulately connections between the sections 4d and 4e; 4d and 5a; 5a and 5b; 5b and 5c; 5c and 5d; 5d and 6a; 6a and 6b; and 6b and 7, respectively.

The adjustable internal frame 1 further comprises pairs of adjusting struts 24a, 24c, 25a and 26a. One end of each of the adjusting struts 24a, 24c, 25a and 26a is articulately connected at an appropriate position to the slidable rail 40. The other end of each of the adjusting struts 24a, 24c, 25a and 26a is then articulately connected to a respective frame strut 14a, 14c, 15a and 16a, at an appropriate position (roughly mid-way) between the base 2 and the section to which the frame strut is connected.

The operation of the adjustable internal frame 1 to change the configuration of the foil 50 can be seen in particular with reference to FIGS. 5a to 5c. These figures do not show all parts of the base 2 and slidable rail 40, but have at the bottom ends of the adjusting struts 24a, 24c, 25a and 26a lines showing their range of movement.

FIGS. 3a, 4a and 5a show the adjustable internal frame 1 in the configuration in which the adjustable foil 50 is in the expanded configuration. In the expanded configuration, the slidable rail 40 is at its position closest to the leading edge of the adjustable foil 50. Thus, the bottom edge of each of the adjusting struts 24a, 24c, 25a and 26a is also at its position closest to the leading edge of the adjustable foil 50. As the slidable rail 40 is fixed vertically within the base 2, this means the adjusting struts 24a, 24c, 25a and 26a are at their most vertical position, so their upper ends are at their greatest distance from the base 2.

This in turn means that the frame struts 14a, 14c, 15a and 16a to which the upper ends of the adjusting struts 24a, 24c, 25a and 26a are articulately connected are at their most vertical position, so their upper ends are at their greatest distance from the base 2. As the upper ends of the frame struts 14a, 14c, 15a and 16a are articulately connected to the sections 4b, 4d, 5a and 6a, those sections are at their greatest distance from the base 2.

Each section (except the first section 4 and trailing section 7) is articulately connected at its ends to two frame struts, which are in turn articulately connected to the base 2 to form a quadrilateral. Being a quadrilateral, each has only a single degree of freedom of movement, namely to change to the angle of the corners of the quadrilateral. Thus, as the sections 4 to 7 are all articulately connected, when one is moved the rest must necessarily move as well, so that they all move together. This single degree of freedom of movement also means the adjustable internal frame 1 is very strong.

Thus, the sections 4b, 4d, 5a and 6a being at their greatest distance from the base 2 necessarily means that all of the sections 4 to 7 are necessarily at their greatest distance from the base 2, so that when the slidable rail 2 is at its position closest to the leading edge of the adjustable foil 50, the adjustable foil 50 is in the expanded position as shown in FIGS. 3a, 4a and 5a.

Conversely, when the slidable rail 40 is moved towards the trailing edge of the adjustable foil 50, as the slidable rail 40 is fixed vertically within the base 2, the upper ends of the adjusting struts 24a, 24c, 25a and 26a are moved towards the base 2, which in turn moves the upper ends of the frame struts 14a, 14c, 15a and 16a towards the base 2, which moves the sections 4b, 4d, 5a and 6a, and so all of the sections 4 to 7, towards the base 2. FIG. 5b shows the adjustable internal frame 1 when the slidable rail 40 has been moved part-way towards the trailing edge of the adjustable foil 50. When the slidable rail 40 has been moved to its fullest extent towards the trailing edge of the adjustable foil 50, each of the sections 4 to 7 is pulled down so that it is flat against the base 2, and the adjustable foil 50 is in the collapsed position shown in FIGS. 3a, 4a and 5a.

In embodiments of the invention, the slidable rail 40 is moved with respect to the base 2 by a drive motor. However, it will be appreciated that in other embodiments, other means to move the slidable rail 40 could be used, such as a hydraulic mechanism.

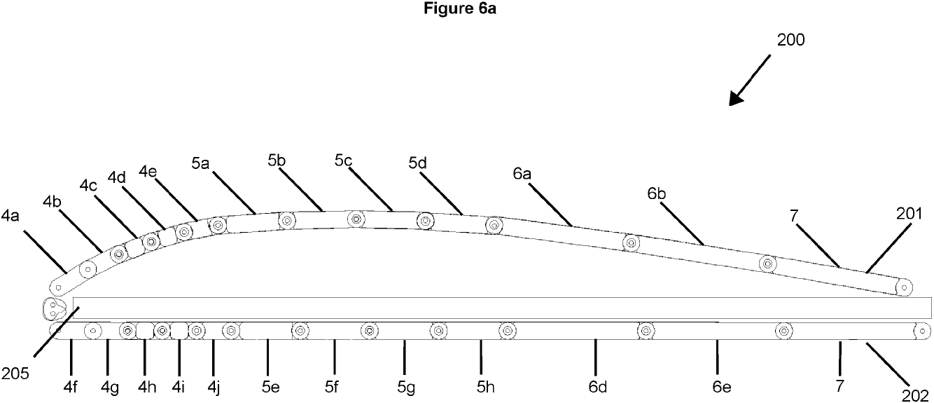

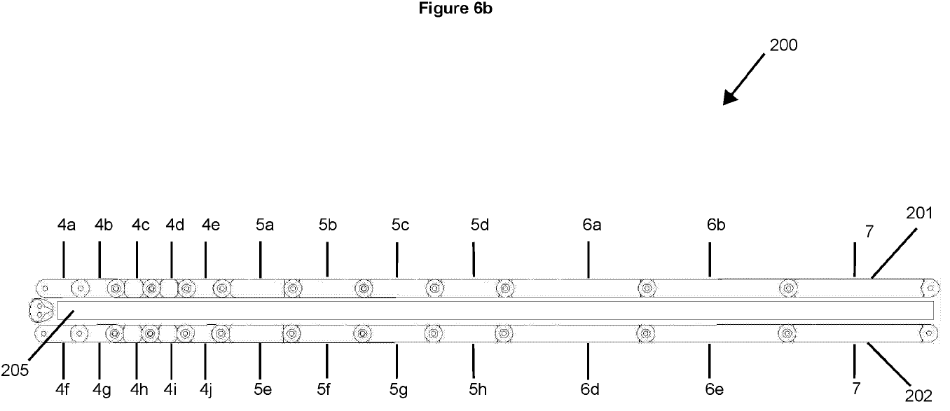

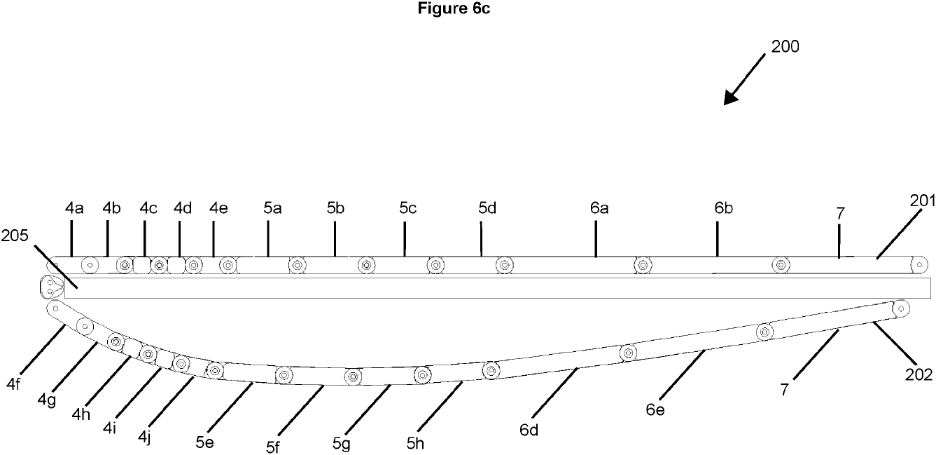

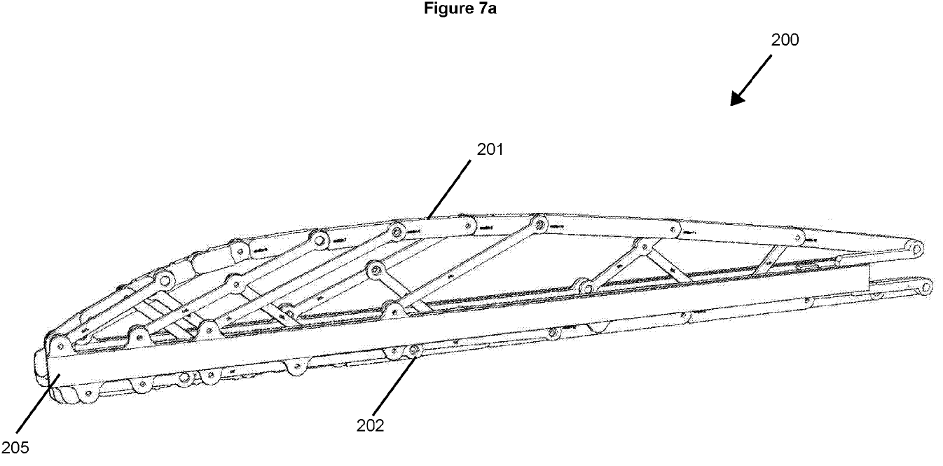

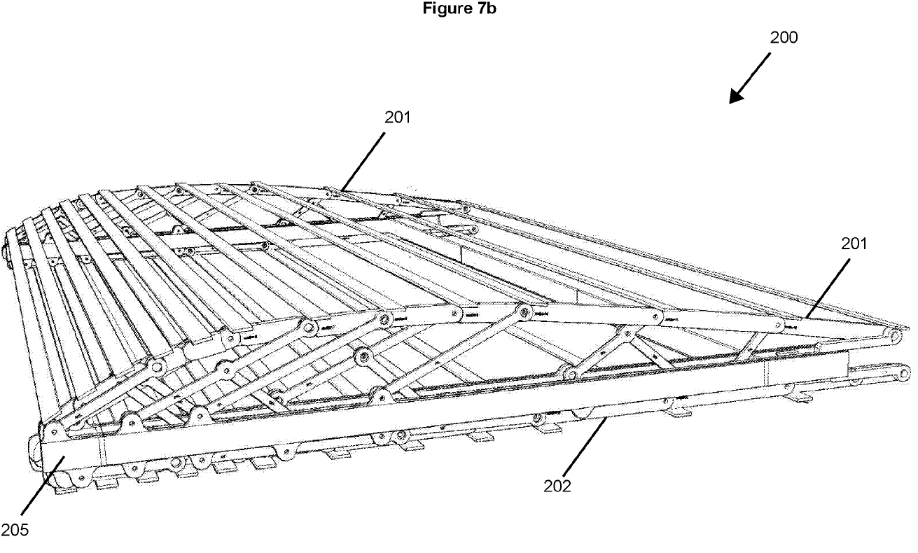

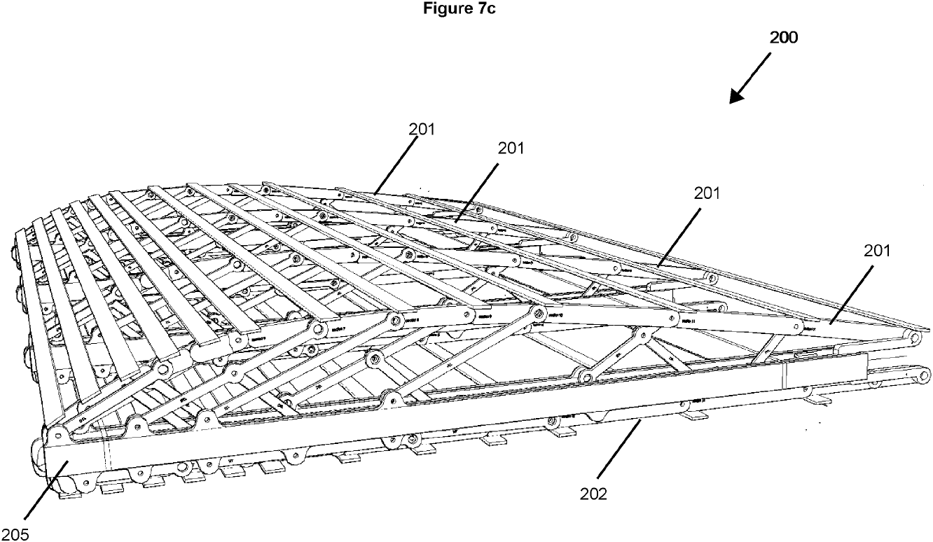

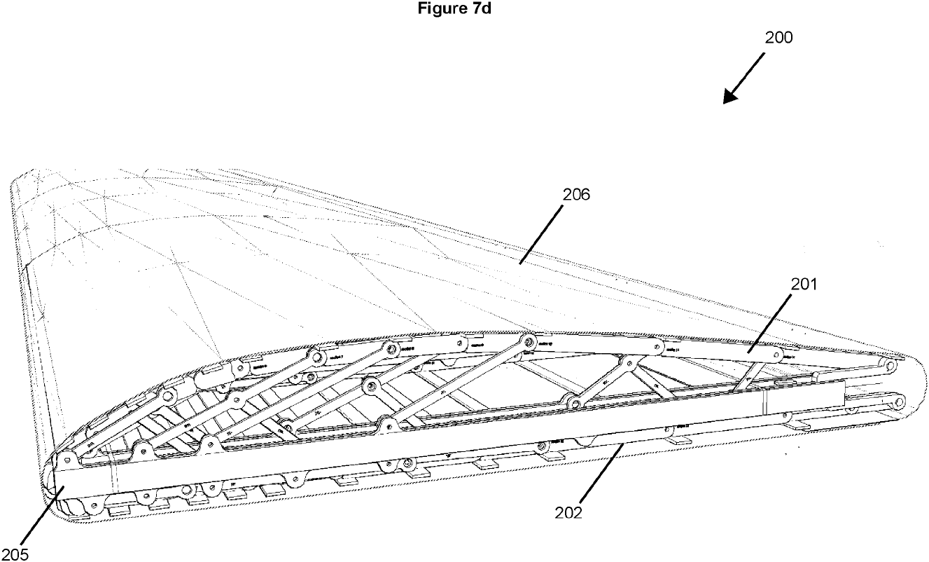

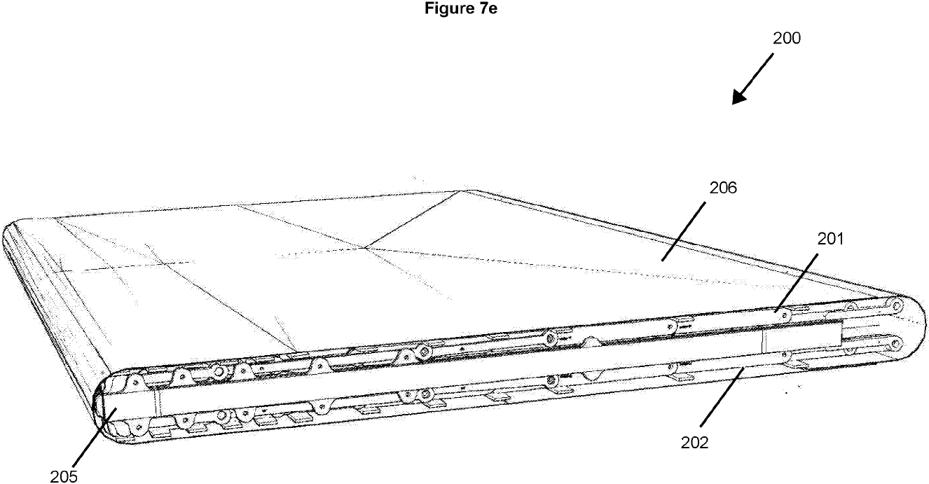

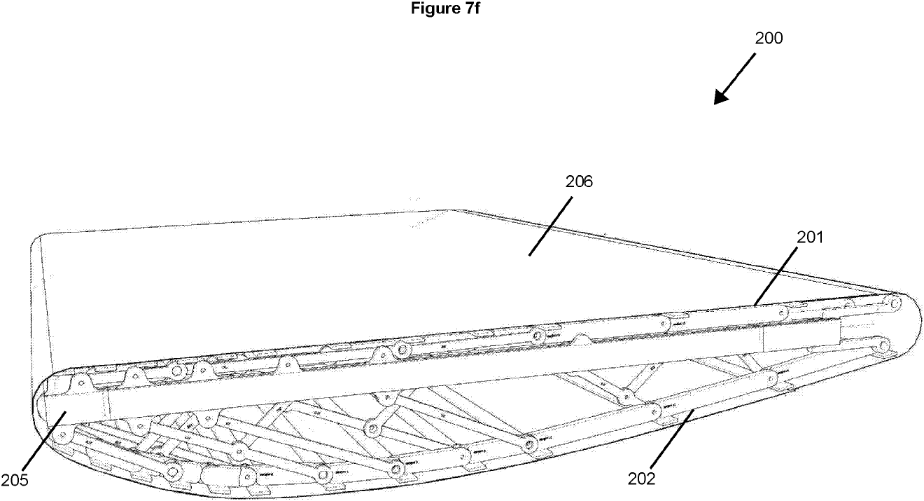

A combination adjustable foil in accordance with a further embodiment of the invention is now described, with reference to FIGS. 6a to 7f. The combination adjustable foil 200 comprises a first adjustable foil 201 in accordance with an embodiment of the invention, onto which is mounted a second adjustable foil 202, also in accordance with an embodiment of the invention. The first adjustable foil 201 and second adjustable foil 202 are in fact identical in construction, with the sections 4a 6c of the first adjustable foil 201 having corresponding sections 4f to 6f of the second adjustable foil 202.

As can be seen in particular from FIGS. 6a to 6c, the first adjustable foil 201 and second adjustable foil 202 are positioned and oriented so that they share a base 205, with the result that the suction surface of the first adjustable foil 201 expands away from the second adjustable foil 202, and similarly the suction surface of the second adjustable foil 202 expands away from the first adjustable foil 201. The first adjustable foil 201 and second adjustable foil 202 are oriented in the same direction from leading edge to trailing edge, so that the leading edge of the first adjustable foil 201 and the leading edge of the second adjustable foil 202 together form the leading edge of the combination adjustable foil 200, and similarly the trailing edge of the first adjustable foil 201 and the trailing edge of the second adjustable foil 202 together form the trailing edge of the combination adjustable foil 200.

As can be seen from FIGS. 7a to 7f, the first adjustable foil 201 and second adjustable foil 202 of the combination adjustable foil 200 comprises multiple sets of sections, struts etc. arranged from one side of combination adjustable foil 200 to the other, to give additional support and strength. Further, as shown in FIGS. 7d to 7f, the first adjustable foil 201 and second adjustable foil 202 of the combination adjustable foil 200 are covered by an outer skin 206.

In this way, it can be seen that the combination adjustable foil 200 can have its upper surface be a suction surface, with the second adjustable foil 202 acting as the pressure surface for the first adjustable foil 201 when the first adjustable foil 201 is in the expanded configuration and the second adjustable foil 202 is in the collapsed configuration. This is the configuration shown in FIGS. 6a to 7a to 7d. Alternatively, the combination adjustable foil 200 can have its lower surface be a suction surface, with the first adjustable foil 201 acting as the pressure surface for the second adjustable foil 202 when the second adjustable foil 202 is in the expanded configuration and the first adjustable foil 201 is in the collapsed configuration. This is the configuration shown in FIGS. 6c and 7f.

Further, with both the first adjustable foil 201 and the second adjustable foil 202 in the collapsed configuration the combination adjustable foil 200 will have no pressure surface, as shown in FIGS. 6b and 7e. It will be appreciated that the first adjustable foil 201 and the second adjustable foil 202 could be used in various different configurations for different effects, for example both in the fully expanded configuration, one fully expanded and one partially expanded, and so on.

While the present invention has been described and illustrated with reference to particular embodiments, it will be appreciated by those of ordinary skill in the art that the invention lends itself to many different variations not specifically illustrated herein. By way of example only, certain possible variations will now be described.

It will be appreciated that in other embodiments of the invention, adjusting struts could be provided on more, fewer and/or different frame struts.

It will also be appreciated that in other embodiments, different arrangements for moving the frame struts could be provided. For example, rather than mounting the adjusting struts on a slidable rail, they could be articulately connected to fixed positions on the base 2, but be adjustable in length. The frame struts could then be moved, to move the foil 50 between the collapsed and expanded configurations, by changing the lengths of the adjusting struts appropriately. Such adjustment could be by means of a drive motor or motors, a hydraulic mechanism, or any other suitable means.

While the adjustable foil 50 described above has a shaped portion 1a of fixed configuration mounted underneath the internal adjustable frame 1 to provide the shape of the pressure surface, it will be appreciated that alternatives could be used, including a further internal adjustable frame arranged the other way up with sections providing the pressure surface, so that both the suction surface and pressure surface can be expanded or collapsed.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An adjustable foil having a suction surface and a pressure surface, each of the suction surface and the pressure surface extending from a leading edge of the foil to a trailing edge of the foil, wherein the foil comprises an adjustable internal frame comprising:
a base;
a plurality of articulately connected sections forming the suction surface of the foil, wherein the plurality of sections are arranged consecutively from the leading edge of the foil to the trailing edge of the foil; and
a plurality of frame struts, wherein each frame strut is articulately connected to the base, and articulately connected to a section of the plurality of sections;
wherein the foil is movable from a collapsed configuration to an expanded configuration by rotating the frame struts with respect to the base.

2. An adjustable foil as claimed in claim 1, wherein the internal frame further comprises one or more adjusting struts, each adjusting strut articulately connected to a frame strut at a point between the base and the section to which the frame strut is articulately connected.

3. An adjustable foil as claimed in claim 2, wherein each adjusting strut is articulately connected to a rail slidably mounted to the base, and wherein the foil is movable from the collapsed configuration to the expanded configuration by moving the rail with respect to the base, to rotate the frame struts with respect to the base.

4. An adjustable foil as claimed in claim 3, further comprising a drive motor to move the rail with respect to the base.

5. An adjustable foil as claimed in claim 2, wherein the length of each adjusting strut can be increased or decreased, and wherein the foil is movable from the collapsed configuration to the expanded configuration by moving the rail with respect to the base, to rotate the frame struts with respect to the base.

6. An adjustable foil as claimed in claim 5, further comprising a drive motor to increase or decrease the length of each adjusting strut.

7. An adjustable foil as claimed in claim 1, wherein each section of the plurality of sections is the same or a smaller length than the sections further from the leading edge of the foil.

8. An adjustable foil as claimed in claim 1, wherein the plurality of sections comprises a first set of sections of a first length and a second set of sections of a second length, wherein the second set of sections is further from the leading edge of the foil than the first set of sections, and wherein the second length is double the first length.

9. An adjustable foil as claimed in claim 8, wherein there are five sections in the first set of sections, and four sections in the second set of sections.

10. An adjustable foil as claimed in claim 8, wherein the plurality of sections further comprises a third set of sections of a third length, wherein the third set of sections is further from the leading edge of the foil than the second set of sections, and wherein the third length is double the second length.

11. An adjustable foil as claimed in claim 10, wherein there are three sections in the third set of sections.

12. An adjustable foil as claimed in claim 8, wherein the plurality of sections comprises a leading section closer to the leading edge of the foil than the first set of sections.

13. An adjustable foil as claimed in claim 8, wherein the plurality of sections comprises a trailing section further from the leading edge of the foil than the second and third sets of sections.

14. An adjustable foil as claimed in claim 1, wherein the base of the internal frame forms the pressure surface of the foil.

15. An adjustable foil as claimed in claim 1, further comprising an outer skin over the internal frame.

16. An adjustable foil as claimed in claim 1, wherein the foil is an aerofoil.

17. An adjustable foil as claimed in claim 16, wherein the foil is a wing.

18-21. (canceled)

22. A combination adjustable foil comprising:
a first adjustable foil as claimed in claim 1, and
a second adjustable foil as claimed in claim 1, mounted on the first adjustable foil,
wherein the second adjustable foil is positioned and oriented with respect to the first adjustable foil so that the leading edge of the first adjustable foil and the leading edge of the first adjustable foil form the leading edge of the combination adjustable foil, the trailing edge of the first adjustable foil and the trailing edge of the first adjustable foil form the trailing edge of the combination adjustable foil, and the pressure surface of the first adjustable foil expands in the opposite direction to the second adjustable foil.

23. A combination adjustable foil as claimed in claim 22, wherein the base of the internal frame of the first adjustable foil is mounted the base of the internal frame of the second adjustable foil.

24. A combination adjustable foil as claimed in claim 22, wherein the base of the internal frame of the first adjustable foil is the base of the internal frame of the second adjustable foil.
